(19) United States
(12) Patent Application Publication
(10) Pub. No.: US 2005/0125038 A1
(43) Pub. Date: Jun. 9, 2005

(54) Unit for delivering a single dosage of a liquid medicine

(75) Inventors: Michael Inbar, Caesaria (IL); Moshe Olshevski, Tel Aviv (IL)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: SUC-MED TECHNOLOGIE LTD, Tev Aviv (IL)

(21) Appl. No.: 10/499,031

(22) PCT Filed: Dec. 16, 2002
(86) PCT No.: PCT/IL02/01010

(30) Foreign Application Priority Data
Dec. 19, 2001 (IL) 147187

(51) Int. Cl. A61J 17/00

(52) U.S. Cl. 606/236

(57) ABSTRACT

A single-dosage liquid medication dispensing unit, especially useful for newborns, babies, and young children, comprising a flexible container containing said liquid medication therein and having a nipple-shaped portion with an orifice for allowing sucking by a newborn, baby, or young child, wherein said orifice is initially in an inactive state and is adapted for being activated by a user just prior to being given to a newborn, baby, or young child for sucking. A method for delivering a single-dosage of a liquid medication is also disclosed.

### FIELD OF THE INVENTION

The present invention generally to a unit for delivering a single dosage of a liquid medicine. More specifically, the present invention relates to a unit for delivering a single dosage of a liquid medicine that is especially useful for newborns, babies, and for young children.

### BACKGROUND OF THE INVENTION

Various pacifiers are known in the art. Many pacifiers have been designed in order to carry out a function other than just “pacifying” the infant by providing a nipple for sucking on. Pacifiers provide a good medium for delivering liquids to an infant, since the infant has a natural instinct for sucking from the nipple. This saves a parent from the hassle of trying to force-feed medications to an infant.

U.S. Pat. No. 6,197,044 discloses a feeding unit and apparatus for infants for facilitating the oral delivery of fluids, such as formula and breast milk, to infants. The unit includes a pacifier having a nipple that has an inner lumen which may removably receive a tube, specifically a feeding or medication tube. U.S. Pat. No. 5,772,685 relates to an infant pacifier-fluid administering unit. The unit includes a flexible nipple having an inlet and a sucking orifice spaced therefrom, and a substantially sealed compressible fluid dispenser having an outlet juxtaposed for fluid communication through a pressurable openable valve whereby fluid in the dispenser can be injected under pressure into the nipple. Both of these inventions, as well as other devices known in the art, do not satisfactorily meet the needs of a liquid-administering pacifier. There is a need for a unit for delivering a liquid medicine that is easy to use, simple in construction, and also low cost.

It is the object of the invention to provide a unit for delivering a single dosage of a liquid medicine to newborn, baby, or a young child in a convenient and hassle-free manner. The unit of the present invention is manufactured and sold with a predetermined single dosage of a liquid medicine contained therein. This saves the parent or health care provider (i.e., doctor or nurse) that trouble of having to precisely measure out the proper dosage, and it also saves from spillage, both during measuring and during administration of the medicine. The parent or health care provider is also ensured that the newborn, baby, or young child is receiving the required safe dosage of the medication. Following usage of the unit, the unit is discarded.

The unit of the present invention is manufactured with a sucking orifice that is initially in an inactive state, so as to preserve the cleanliness and sterile environment of the unit and of the medication therein. The sucking orifice is activated just prior to giving to the newborn, baby, or infant, for sucking. The unit of the present invention is totally clean and sterile, and the liquid medicine that is administered is well-preserved and maintained inside of the unit until usage. Furthermore, since most babies do not like to take medicine, the utilization of the sucking instinct of the infant makes talking medication a much more bearable and pleasant experience both for the parent and for the infant.

These and other features and advantages of the present invention will be more readily understood and appreciated from the summary of the invention and the detailed description of the drawings that follow.

### SUMMARY OF THE INVENTION

The present invention relates to a single-dosage liquid medication dispensing unit, especially useful for newborns, babies, and young children, comprising a flexible container containing said liquid medication therein and having a nipple-shaped portion with an orifice for allowing sucking by a newborn, baby, or young child, wherein the orifice is initially in an inactive state and is adapted for being activated by a user just prior to being given to a newborn, baby, or young child for sucking.

In the context of the present invention, the term “inactive state” refers to a state in which the orifice is effectively closed (for example, by sealing, blocking, or covering) and therefore cannot be sucked from. In the context of the present invention, the term “activation” of the orifice refers to the step of making the orifice effectively open so as to allow for sucking.

The unit of the present invention is useful for giving medication to any infant, baby, or young child still of the age of sucking from a nipple. It is appreciated that the present invention takes advantage of the natural sucking instinct in order to male medicine administration, a normally unpleasant and timely process, more tolerable and agreeable to the infant, baby, or young child.

According to preferred embodiments of the present invention, the unit includes a covering positioned over said flexible container. The flexible container may be formed from any appropriate material that is customarily used for nipples and pacifiers (for example, silicon or latex). The covering is preferably formed from a more rigid material (specifically, the covering should be rigid at the region that covers the orifice of the container) such as a rigid polymeric material (for example, PET). In certain preferred embodiments, the covering is hermetically sealed over the container of the unit. The covering offers the advantage of providing a safety sealing around the container, thereby maintaining the cleanliness and sterileness of the unit and preventing the degradation of the liquid medication contained inside of the container. The covering is preferably formed from a material that is not permeable to oxygen, since oxygen can degrade the flexible material of the container. Furthermore, the covering protects the container and the medication from degradation that may result from light penetration. Moreover, in some preferred embodiments, the space between the container and the covering is filled with an inactive gas, such as nitrogen.

According to preferred embodiments of the present invention, the covering is designed so as to seal closed the orifice, making the orifice inactive until the cover is removed. Thus, the user is provided with the unit with the orifice in the inactive configuration, and just prior to usage, the orifice is activated, preferably through the removal of the cover.

According to preferred embodiments of the present invention, the covering is sealed to the container directly over the orifice. Alternatively, the covering is sealed to the container around said orifice.

According to preferred embodiments of the present invention, the covering is adapted to be broken open by the user just prior to usage. In these preferred embodiments, the covering is adapted for constricting the container in the central region thereof such that the liquid medication cannot pass to the orifice of the container.

Preferably, the covering is adapted in design and construction so as to maintain the sterility of the unit. It is furthermore preferably adapted for maintaining the hygienity of the unit. Thus, the user is ensured that the unit is not contaminated in any way and that the quality of medicine that is being administered has not been compromised during handling and processing of the unit. In certain preferred embodiments, the covering is adapted to protect against the entry of external, potentially harmful molecules, for example, oxygen. Moreover, the covering may be adapted for protecting the unit against irradiation, which can also have a damaging effect on the liquid medicine in the container.

According to preferred embodiments of the present invention, the unit further comprises a sealing element positioned at least partially inside of the orifice for sealing the orifice and adapted for being removed from the orifice just prior to usage. Preferably, the sealing element has a triangular shape. The sealing element may or may not be attached to the covering. It is appreciated that when attached to the covering, the sealing element becomes disengaged from the orifice when the covering is removed. When not attached to the covering, the sealing element needs to be removed by the user following the removal of the cover.

According to preferred embodiments of the present invention, the unit further comprises a sealing device positioned inside the container and directly below the orifice so as to inactivate the orifice (by blocking said orifice and the region directly below said orifice so that the liquid cannot reach there), wherein the sealing device is adapted for being pushed down (preferably by pressing on the orifice area with a finger) just prior to usage so as to make the orifice active. After being pushed down, the newborn, baby, or young child is now able to suck the liquid from the orifice. Preferably, said sealing device is in the shape of a ball (a sphere), though other shapes and designs are possible as well, in order to conform to the inner contours of the sucking area of the container while blocking off said area to the package of liquid.

According to preferred embodiments of the present invention, the container is adapted for holding 0.5-10 ml of fluid.

The present invention also relates to a method for delivering a single-dosage of a liquid medication, especially useful for newborns, babies, and young children, comprising;
(a) providing a flexible container containing said liquid medication therein and having a nipple-shaped portion with an inactive orifice;
(b) activating said orifice just prior to giving to a newborn, baby, or young child for sucking.

In the context of the present invention, the term “liquid medicine” or “liquid medication” is not meant to refer strictly to only medicinal liquids but may refer to other health-promoting liquids as well, such as formula, liquid vitamins, etc. . . . In one preferred embodiment, the liquid may comprise a composition consisting of at least one of the group including: sucrose, glucose, and artificial sweeteners.

Preferably, the method described further includes the step of introducing a covering over the flexible container. During manufacture of the unit of the present invention, an opening in the bottom of the container is utilized for filling said container with the single dosage of liquid medication. Following filling, the opening is sealed through any appropriate means such as welding or lamination. According to preferred embodiments of the present invention, the opening is closed with a rigid cover that preferable provides a base to which the covering is attached during manufacture. The rigid cover preferably also serves to protect the container from being accidentally swallowed during sucking by the newborn, baby, or young child.

In some preferred embodiments, the method for manufacture of the unit of the present invention further comprises filling the space between the covering and the container with an inert gas so as to prolong the shelf life of the liquid medicine. In one preferred embodiment, the inert gas comprises nitrogen.

Preferably, the orifice of the container which will eventually be employed for sucking is initially made inactive by the manufacturer through any of the ways previously described. When the end user desires to give the unit to a newborn, baby, or young child, the orifice is activated, for example, by removing the covering of the container.

### BRIEF DESCRIPTION OF THE DRAWINGS

The invention is herein described, by way of example only, with reference to the accompanying drawings, wherein:

FIGS. 1A, 1B, and 1C represent a single-dosage liquid medication dispensing unit, especially useful for newborns, babies, and young children, according to a first preferred embodiment of the present invention. FIG. 1A is a cross-sectional side view of the unit. FIG. 1B illustrates an enlarged portion of the cross-section of FIG. 1A. FIG. 1C is an isometric view of the unit.

FIGS. 2A and 2B represent a single-dosage liquid medication dispensing unit, especially useful for newborns, babies, and young children, according to a second preferred embodiment of the present invention. FIG. 2A is a cross-sectional side view of the unit, and FIG. 2B is an isometric view of the unit.

FIGS. 3A and 3B represent a single-dosage liquid medication dispensing unit, especially useful for newborns, babies, and young children, according to a third preferred embodiment of the present invention. FIG. 3A is a cross-sectional side view of the unit, and FIG. 3B is an isometric view of the unit.

FIGS. 4A and 4B represent a single-dosage liquid medication dispensing unit, especially useful for newborns, babies, and young children, according to a fourth preferred embodiment of the present invention. FIG. 4A is a cross-sectional side view of the unit, and FIG. 4B is an isometric view of the unit.

FIGS. 5A and 5B represent a single-dosage liquid medication dispensing unit, especially useful for newborns, babies, and young children, according to a fifth preferred embodiment of the present invention. FIG. 5A is a cross-sectional side view of the unit, and FIG. 5B is an isometric view of the unit.

FIGS. 6A and 6B represent a single-dosage liquid medication dispensing unit, especially useful for newborns, babies, and young children, according to a sixth preferred embodiment of the present invention. FIG. 6A is a cross-sectional side view of the unit, and FIG. 6B is an isometric view of the unit.

### DETAILED DESCRIPTION OF THE DRAWINGS

It is appreciated that the detailed description provided is meant only to explain and clarify certain preferred embodiments of the present invention. It is in no way meant to limit the scope of the invention, as set out in the claims.

The unit of the present invention includes a container having an inactive (effectively closed) orifice for sucking. The orifice is activated, to enable sucking, just prior giving to a newborn, baby, or young child. It is appreciated that this preserves the safety and sterility of the unit and also prevents leakage of the liquid medication from inside the container. The unit is for one-time use only, and contains a predetermined dosage of a specific liquid medication therein. After usage, it is discarded. It may be manufactured in a range of sizes, to accommodate children of different ages, for example, newborns, 1 year-olds, and 2 year-olds. It may also be manufactured in size to accommodate different amounts of liquid medicine, preferably, between 0.5-10 ml.

The liquid medication is introduced into the container during the manufacture of the container, preferably via an opening located at the bottom of the container (opposite from the orifice). After introduction of the liquid medicine, said opening is closed through any appropriate means, such as welding or glue. Furthermore, the unit of the present invention is provided to a user inside of a sealed packaging, for optimum safety.

The inactivating means that serve to make the orifice of the pacifier inactive until just prior to use may vary between preferred embodiments. Six different preferred embodiments will be described, though it is appreciated that numerous other possibilities exist as well.

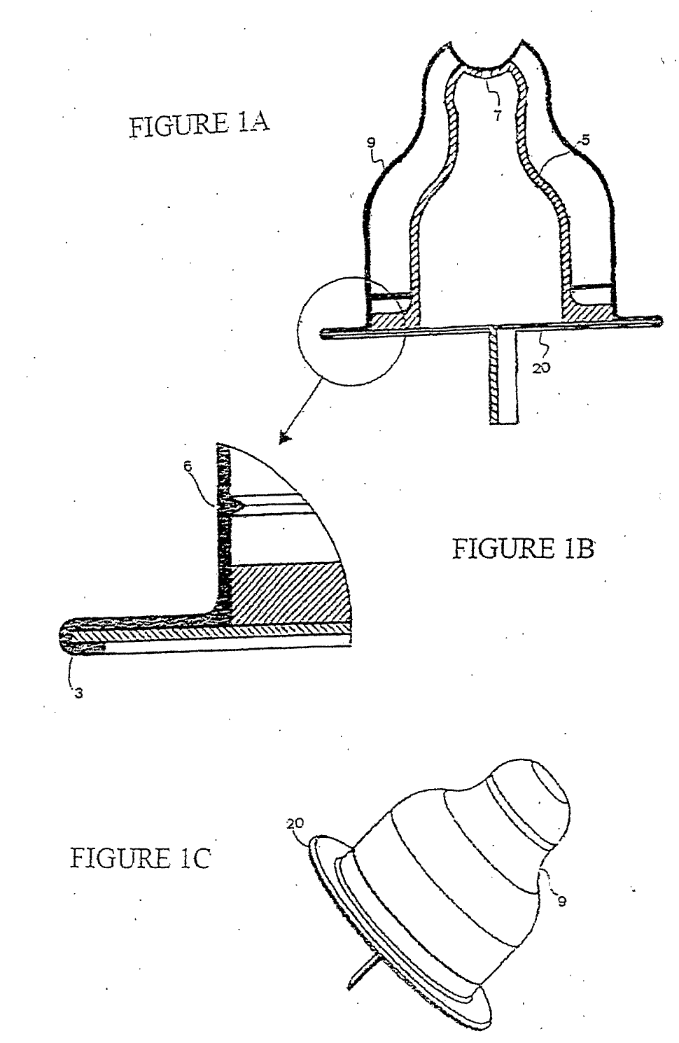

Referring first to FIG. 1A, the unit of the present invention, according to a first preferred embodiment, includes a container (5) having an orifice (7) at one end thereof. The end of the container is designed like a nipple for fitting comfortably into the mouth of a newborn, baby, or infant. The orifice (7) is initially in an inactive state, due to a covering (9) positioned over the container (5) and sealed through the application of external pressure directly over the orifice (7). The covering (9) may include a perforation (6), seen in FIG. 1B, that facilitates easy removal of the covering at the time of usage. Alternatively, the bottom of the covering may have a fold (3) that is positioned around the end of the covering, also for enabling easy removal of the covering. FIG. 1C shows an isometric view of the unit. During manufacture of the unit of the present invention, the flexible container (5) is filled with the liquid medicine via an opening in the bottom of the container (5). Preferably, said opening is thereafter closed using a rigid cover (20).

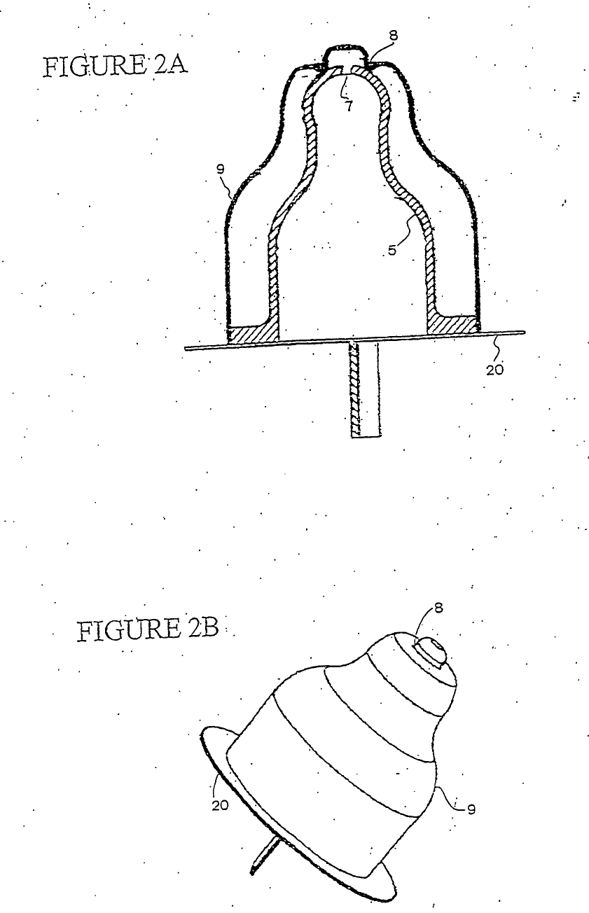

Reference will now be made to FIGS. 2A and 2B, and to a second preferred embodiment of the present invention. In this preferred embodiment, the covering (9) is placed and pressured over the container (5) so as to form a circular seal (8) around the orifice (7) of the container (5). The orifice (7) is thereby inactivated until the time that the covering is removed by the user, just prior to giving the container to the newborn, baby or young child.

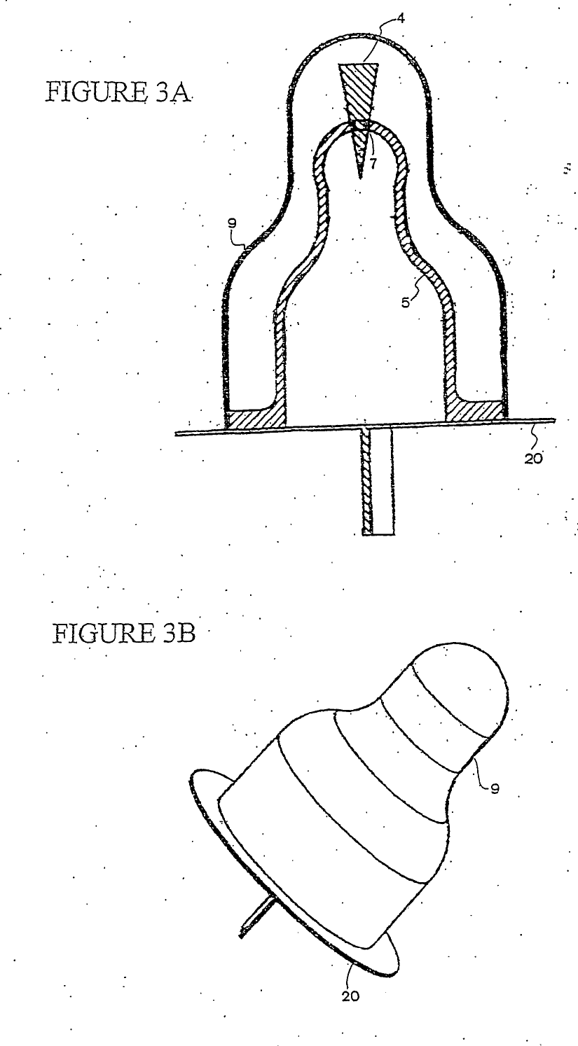

In the preferred embodiment shown in FIGS. 3A and 3B, the orifice (7) is made inactive by a sealing element (4) that is partially engaged inside of said orifice (7). The sealing element (4) is made of rigid material (for example, plastic), such that it functions to effectively seal the orifice. Preferably, the sealing element (4) has a generally triangular shape (other appropriate shapes are also possible). The sealing element (4) is attached to the covering (9) such that when the covering (9) is removed by the user, the sealing element (4) becomes disengaged from the orifice (7), and the orifice (7) is activated.

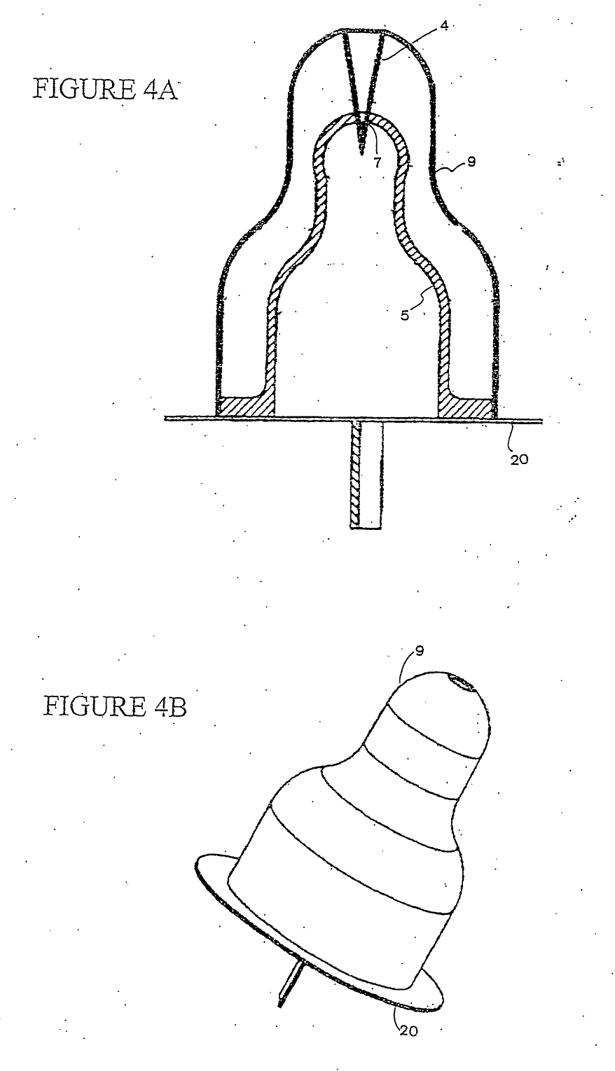

The preferred embodiment illustrated in FIGS. 4A and 4B is similar to that of FIGS. 3A and 3B, except that the sealing element (4) is not attached to the covering (9) and is therefore removed separately from the covering (9), in order to change the orifice from an inactive state to an active state.

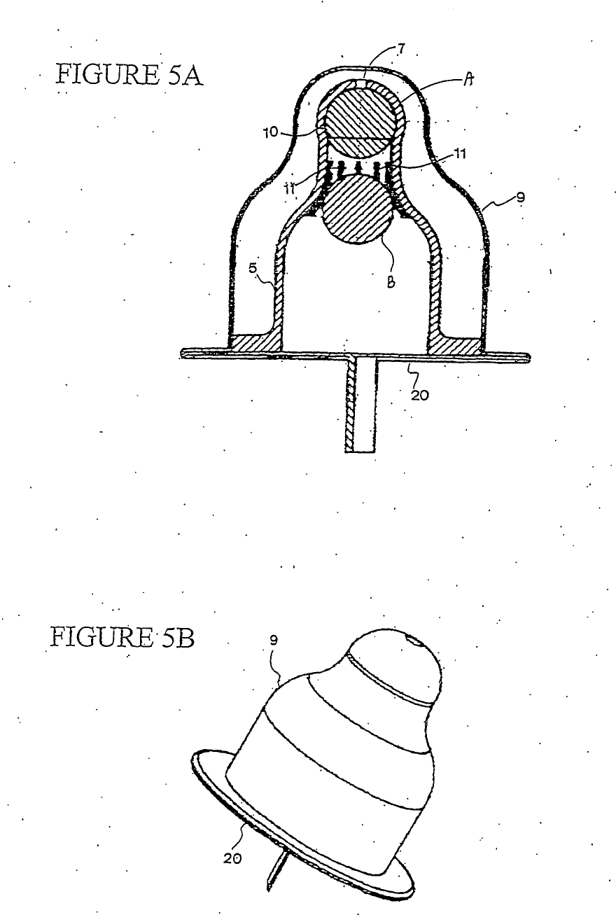

In the preferred embodiment illustrated in FIGS. 5A and 5B, the orifice (7) is inactivated by a sealing device (10) located inside of container (5). In its initial position (A), located at the very top of the container (5), the sealing device serves to block the orifice (7) of said container (5). The sealing device (10) preferably has a spherical shape, is formed from substantially rigid material. Thus, the sealing device (10) creates pressure against the inner sides of the upper portion of the container (5) (in the region of the orifice) such that the orifice (7) is effectively inactivated and so that the liquid medicine in the container (5) cannot pass to the region of the orifice (7). When the orifice is to be activated, the user removes the covering (9) of the container (5) and pushes down onto the orifice (7). This causes the sealing member (10) to become lowered to a second position (B), wherein the orifice (7) is active and the liquid medicine is allowed to said orifice (7) when the orifice is sucked from. A plurality of fingers (11) serve to trap the sealing member (10) in the central region of the container (5) (while allowing for the liquid to pass to the orifice of the container around the sides of said sealing member).

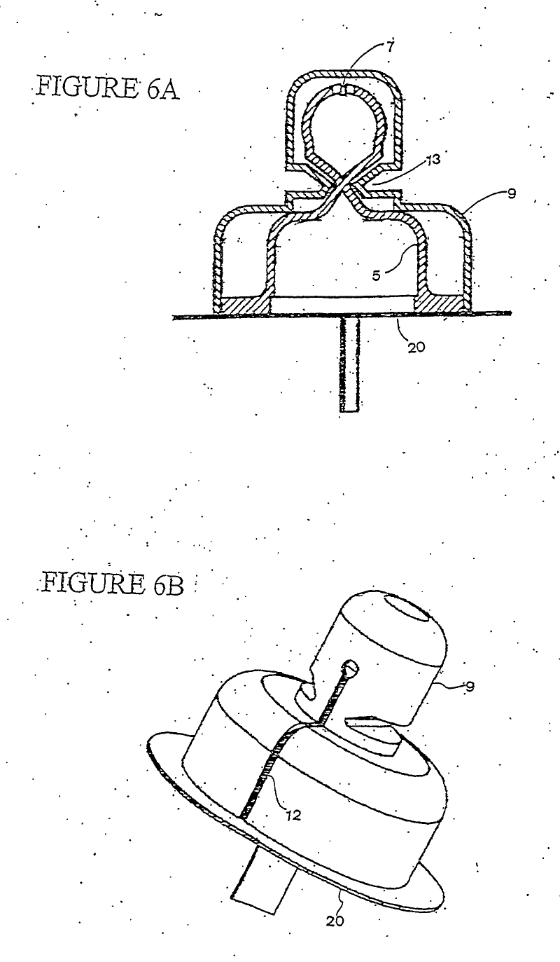

Referring to FIGS. 6A and 6B, in the preferred embodiment shown, the covering (9) of the container (5) is fitted and pressured over the container (5) so as to create a constriction (13) in the middle section of the container (5). Liquid is unable to pass from the lower section of the container (5) to the upper section (where the orifice (7) is located) due to said constriction (13). When the covering (9) is removed, the constriction is eliminated and a space is created for the passage of the liquid to the region of the orifice (7). Preferably, removal of the covering (9) is facilitated by the presence of a groove (12) (seen only in FIG. 6B) which serves to effectively divide the covering (9) into two sides. When the user wants to remove the covering (9), the sides of said covering (9) are broken from one another.

1. A single-dosage liquid medication dispensing unit, especially useful for newborns, babies, and young children, comprising a flexible container containing said liquid medication therein and having a nipple-shaped portion with an orifice for allowing sucking by a newborn, baby, or young child, wherein said orifice is initially in an inactive state and is adapted for being activated by a user just prior to being given to a newborn, baby, or young child for sucking.

2. A unit according to claim 1, further comprising a covering positioned over said flexible container.

3. A unit according to claim 2, wherein the covering is formed from rigid material.

4. A unit according to claim 2, wherein the removal of said covering results in activation of the orifice.

5. A unit according to claim 4, wherein the covering is sealed to said container directly over the orifice.

6. A unit according to claim 4, wherein the covering is sealed to said container around said orifice.

7. A unit according to claim 4, wherein the covering is adapted to be broken open by the user just prior to usage.

8. A unit according to claim 7, wherein the covering is adapted for constricting the container in the central region thereof such that the liquid medication cannot pass to the orifice of the container.

9. A unit according to claim 2, wherein the covering is adapted for maintaining the sterility of the container and of the liquid medicine therein.

10. A unit according to claim 2, wherein the covering is adapted for maintaining the hygiene of the container and of the liquid medicine therein.

11. A unit according to claim 2, wherein the covering is adapted for protecting against Othe penetration of external molecules.

12. A unit according to claim 2, wherein the covering is adapted for protecting the liquid medicine against irradiation.

13. A unit according to claim 1, further comprising a sealing element positioned at least partially inside of the orifice for sealing said orifice and adapted for being removed from said orifice just prior to usage.

14. A unit according to claim 13, wherein the sealing element has a triangular shape.

15. A unit according to claim 13, wherein the sealing element is attached to the covering.

16. A unit according to claim 1, further comprising a sealing device positioned inside the container and directly below the orifice so as to inactivate said orifice, wherein said sealing device is adapted for being pushed down just prior to usage so as to make the orifice active.

17. A unit according to claim 16, wherein the sealing device has the shape of a ball.

18. A unit according to claim 1, wherein the container is adapted for holding 0.5-10 ml of fluid.

19. A method for delivering a single-dosage of a liquid medication, especially useful for newborns, babies, and young children, comprising; (a) providing a flexible container containing said liquid medication therein and having a nipple-shaped portion with an inactive orifice; (b) activating said orifice just prior to giving to a newborn, baby, or young child for sucking.

20. A method according to claim 19, wherein the liquid medication comprises a composition containing a predetermined amount of at least one of the group consisting of sucrose, glucose, and artificial sweeteners.

21. A method according to claim 19, further comprising introducing a covering over said flexible container.

22. A method according to claim 21, further comprising filling the space between said covering and said container with an inert gas so as to prolong the shelf life of the liquid medicine.

23. A method according to claim 22, wherein the inert gas is nitrogen.

24. A method according to claim 21, wherein the flexible container includes an opening at the bottom end thereof for enabling filling of said container with said liquid medicine.

25. A method according to claim 24, wherein the step of providing a flexible container containing said liquid medication therein and having a nipple-shaped portion with an inactive orifice includes the step of filling said container with said liquid medicine and closing said opening with a rigid cover.

26. A method according to claim 25, wherein the rigid cover is adapted for producing a base for said covering to be attached to.

27. A method according to claim 25, wherein the rigid cover is adapted for protecting the container from being accidentally swallowed during use.
